(19) United States
(12) Patent Application Publication
(10) Pub. No.: US 2010/0181126 A1
(43) Pub. Date: Jul. 22, 2010

(54) Electric car battery charging system

(76) Inventor: Fred F. Penrod, Bonita Springs, FL (US)

Correspondence Address: Fred F. Penrod, 25241 Golf Lake Circle, Bonita Springs, FL, 34135, US

(21) Appl. No.: 12/583,003

(22) Filed: Aug. 13, 2009

Related U.S. Application Data
(60) Provisional application No. 61/205,125, filed on Jan. 16, 2009.

(51) Int. Cl. B60W 10/18; B60W 20/00

(52) U.S. Cl. 180/65.285; 180/65.21

(57) ABSTRACT

A battery charging system useful for use in a hybrid or an all electric vehicle. The system includes a computer that controls all the multiple generators in the vehicle. The generators are driven by all four wheels of the vehicle plus a small gasoline engine from time to time. The system takes advantage of the brake rotor discs by driving a generator by each of the brake discs in direct contact therewith or by induction. The charging system could also be operated from a disc that is driven from an axle of the vehicle. In this case the extra disc would be mounted onto the axle by way of a housing. The computer controls the charge of the main battery but also could provide charging electricity to an independent battery that is in a standby mode. In this manner very little or no fossil fuel is being consumed by the vehicle no matter what the speed it is being operated at. The system includes a small gasoline engine which is controlled by the computer to alternatingly charge the master battery or a stand-by battery as well as a third independent battery that supplies power to various other minor operating needs of the vehicle

This application is C-I-P of the provisional application No. 01/205,125 and having a filing date of Jan. 16, 2009.

### BACKGROUND OF THE INVENTION

There are cars manufactured these days that are so-called Hybrid cars that are using internal an combustion engine for one part of the car propulsion and in the alternative-use an electric motor to drive the wheels of the car in certain circumstances. It stands to reason that the battery in the vehicle gets a constant workout and must be kept in a well charged condition. Various systems are in use and are proposed to keep the battery of the vehicle in top condition. In certain hybrid vehicles, the braking system is used to generate electric power to keep the battery of the vehicle charged as much us possible. Other designs have been proposed to use the air draft of the moving vehicle to keep the battery charged. That is, when the vehicle is in motion, the relative speed of the vehicle when compared to the ambient air, creates an air stream that is guided into a chamber having turbines therein that, when rotating, drive a generator which in turn will generate electricity for the battery charging system. Also, the bodies of vehicles have been modified to create tunnels which capture the driving air stream, which again will drive turbines. The turbines will be used to drive generators which will produce electricity to charge onboard batteries.

### BRIEF DESCRIPTION OF THE INVENTION

The inventive concept is based on energy derived from the rotating wheels of the car. The energy to charge a battery is derived from an energy capture unit mounted in a manner or location where it will not interfere with any of the vehicles operating units. The energy capturing unit is mounted close to any of the rotating wheels. One example is the rotating discs or rotor of the brake which is always rotating when the vehicle is in motion. The rotating disc can be in used conjunction with a direct driving element that will drive a generator which in turn will produce charging electricity. The rotor of the disc brake can also be used to produce electricity on the well known induction principle. That is, a rotating body produces electric energy by magnetic properties and thereby an electric charge or an electromotive force in a neighboring body without contact. The rotating disc can also be mounted in its own housing on an axle resulting in the same production of electric power. By using the brake disc rotor, the construction can be very much simplified because the rotating disc is already in place. A separate disc involves more of a structural modification of the vehicle axle but it is independent of the rotor disc of the braking system which needs different services at different times.

### BRIEF DESCRIPTION OF THE DRAWINGS

FIG. 1 is a schematic of the distribution of the generated electricity;

FIG. 2A illustrates how a brake rotor is used to generate electricity.

FIG. 2B is a more detailed illustration of FIG. 2A;

FIG. 3 shows another way of generating electricity;

FIG. 4 is still another way of generating electricity.

### DETAILED DESCRIPTION OF THE INVENTION

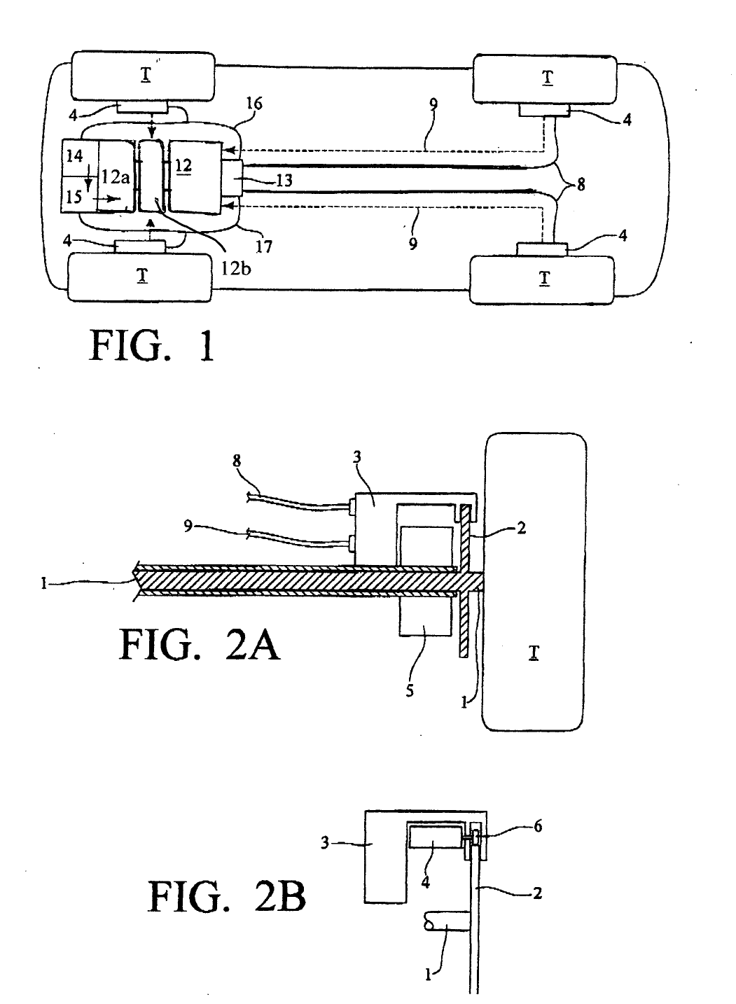

FIG. 1 represents a schematic of the controlling computer of the recharging system. Also shown in this schematic are four tires T. Each tire or wheel operates a generator 4, the details of which will be described below. From each generator 4 there are at least two lines leading to the computer 13. The line 8 is a computer connection and the line 9 carries the electricity generated by the generators 4 to the computer 13 which will determine when and how much of the generated electricity will be used to charge the main battery 12. The computer 13 has no other function but to monitor and activate and control all matters having to do with powering facilities of the vehicle. Since there are 4 possibly operating generators driven by the wheels there may be an excess of electricity being generated while the vehicle is in motion. This excess in electricity may be used to charge an extra and independent battery that may be used when the power of the main battery 12 is exhausted and the exhausted battery may be interchanged with a newly charged battery. All of this is controlled by the computer 13. This may increase the distance that an all electric vehicle can travel to no end because there is always a fully charged battery available. In FIG. 1 there is also shown a small gasoline engine 14, which drives its own electricity producing generator 15. This gasoline engine is to be used only when the main battery 12 needs to be initially charged to get the vehicle in motion.

FIG. 2A shows A system that uses a rotor of a disc 2 brake to generate electricity. At 3 is the generator housing which will be shown in more detail in FIG. 2B. The generator housing has an extension that is in contact with the disc brake or rotor 2. The axle end of this system is shown at 1. Of course, this axle end can be derived from any type of wheel support. The axle 1 could be connected to a differential in a rear wheel drive. The axle 1 could be a swing axle or it could be a short axle in an independently wheel suspension system. The axle 1 is supported by a support 5 which is only shown schematically here. The support could be connected to the conventional shock absorber or any other known system. From the generator housing 3 there extends the connector line 8 to the computer and the electrically charged wire 9 is also connected to the computer.

FIG. 2B is a more detailed showing of how the generator 4 can be driven to generate electricity. In this scenario the brake rotor 2 could have a gearing ring at its outer periphery which in turn would engage a pinion 6 which would rotate the generator shaft which is supported in the generator housing 3. It stands to reason that a gearing system driven in high speed would create a whining noise. The gearing drive could be replaced by a belt drive system (not shown) which is the equivalent of a direct drive.

FIG. 3 shows a different driving system for the generator 4. In this installation there is a separate disc drive 10 for the generating of electricity. This separate disc drive may be advisable in many instances because, when using the brake rotor, the brake rotor needs servicing every so often because the surface of the rotor needs to be serviced after a certain period of time. This would leave the disc drive for the generator untouched which may be advantageous. The separate disc drive 10 would be supported in its own generator housing 7.

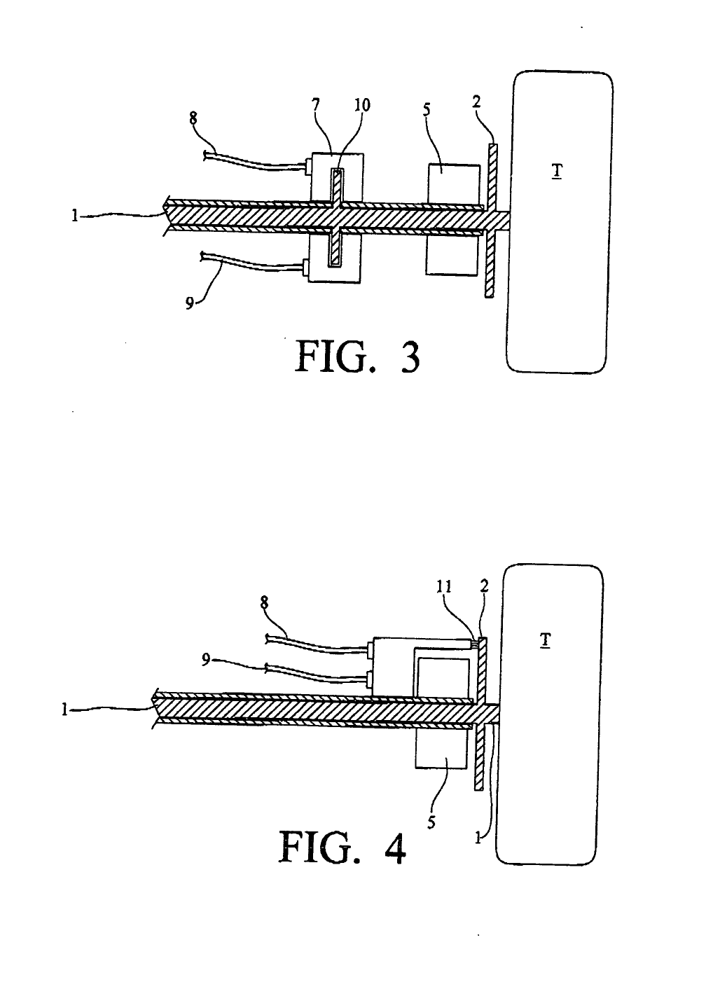

FIG. 4 is still another system of generating electricity by way of induction from any of the wheels represented by the tire T. The well known principle of induction by which a body having electric or magnetic properties produces magnetism or an electromotive force in a neighboring body without contact when moved relative to each other at certain speeds. In this system there is no contact between the generator shaft of the generator 4 which is a stationary magnetic pole of the generator and the rotating brake rotor or a rotating disc when a separate disc is used as shown in FIG. 3. The latter system seems to be the best choice since no contact is made between moving parts or bodies which are moving at a high speed.

There are several scenarios of operation.

1. The vehicle is parked in the owner's garage for several days without any use. The owner may have chosen to keep the master battery 12 charged by using the “plug-in” feature from a standard electrical source in the residence. However, during the non-operative time due to a storm, the household electricity has been cut off. The owner engages the small gasoline engine 14 which then will charge the main battery 12 by way of the generator 15 and the owner will then be able to safely use the vehicle.

2. The user of the vehicle leaves home on local errands. The vehicle never travels at a speed of more than 35 mile per hour. And, therefore, the four sub sources (generators 4) are not effectively or efficiently employed. The primary source of electrically generation is used exclusively in this case but very little fossil fuel is consumed.

3. The owner is taking a long distance trip. He starts from point A with a fully charged master battery 12. It takes perhaps 20 miles to get to the freeway system and during this period, the primary source engine 14 maintains the electrical charge level in the master battery 12 by means of the generator 15.

The owner reaches the freeway where the speed limit may be 70 MPH. The owner chooses to travel at 60 MPH. When the vehicle speed crosses the speed window of 35 MPH, the primary generating source is automatically turned off by the on-board computer and the sub-source mode is engaged and the requirement for the consumption of fossil fuel is removed. However, traveling at the speed of 60 MPH, the master battery 12 may only require the input of 2 of the sub-sources (generators 4) to maintain its proper operating performance level and the on-board computer system therefore engages only 2 of the sub-sources. The computer can be so programmed that the electricity generated by the two non-engaged sub-sources can be used to charge or keep charged another stand-by or independent battery for future use. However, the driver of the vehicle decides that there is a need to increase the operating speed to the 70 MPH speed limit. In doing so, the master battery 12 asks for more generating power and the on-board computer responds by engaging the other 2 sub sources of power.

Consistent variation of speeds does not necessarily call upon the computer 13 to constantly change the generating power call between 2 and 4 generators 4 since there is “carry over” power factor keyed into the master battery 12 that allows for these variations. The computer recognizes this and is aware of when supplemental power charging to the master battery 12 is required and handles this requirement automatically. The driver of the vehicle on a long trip will generally not physically be aware of the changes taking place but will be able to monitor them on the dash-board control dials. After 200 miles of operation without the use of fossil fuel, the operator chooses to make a rest stop at point B. As the person slows the vehicle to enter the rest stop, the speed window is again crossed and at that speed of 35 MPH, the onboard computer restarts the primary source engine 14, 15 and turns off the 4 sub-sources. The primary source internal combustion engine maintains the electrical supply requirements of the master battery until the driver again enters the freeway and elevates the speeds to the desired speeds.

The on-board computer maintains control of the Master battery charge level or any other independent battery charge level and regulates the sources from where the charges will originate without any intervention from the operator of the vehicle.

All references to speeds or generator/battery capacities are general in nature and are not intended to be specific. They are used solely for points of examples. The main battery may additionally have a second battery in a stand-by manner which is wired in series with the main battery. When the main battery is exhausted or depleted, the computer will automatically switch over to the second stand-by battery which then becomes the new source of the electric power. However, the computer may also be charging a totally independent battery which could be used for different purposes, such as a use in another vehicle. The four subcomponent charging systems are capable of accomplishing all of the foregoing scenarios.

What I claim is:

1. A battery charging system for use in a hybrid vehicle being driven by an electric engine and a main battery, said charging system employing a multiple of electricity generating sources being driven by rotating elements of said vehicle, said charging system is being controlled by an on-board computer.

2. The battery charging system of claim 1, wherein said rotating elements are brake discs of said vehicle.

3. The battery charging system of claim 2, wherein a generator shaft is being rotated by said brake disc.

4. The battery charging system of claim 3, wherein said generator drive shaft is being driven by direct contact by said brake disc.

5. The battery charging system of claim 1, wherein said rotating elements charge said battery by induction in combination with generators.

6. The battery charging system of claim 1, wherein said rotating elements each are a disc rotating in a housing on an axle of said vehicle.

7. The battery charging system of claim 1, wherein said computer controls said charging system to charge a stand-by battery in series with said main battery.

8. The battery charging system of claim 1, wherein said computer controls said charging system to charge an independent battery which is separate and apart from the overall system.

9. The battery charging system of claim 1, wherein a small gasoline engine is controlled by said computer to alternatingly charge said master battery or a stand-by battery
